(19) United States
(12) Patent Application Publication
(10) Pub. No.: US 2024/0226796 A1
(43) Pub. Date: Jul. 11, 2024

(54) DEVICE FOR PURIFYING GAS

(71) Applicant: ATLAS COPCO AIRPOWER, NAAMLOZE VENNOOTSCHAP, Wilrijk (BE)

(72) Inventor: Danny Etienne A. VERTRIEST, Wilrijk (BE)

(73) Assignee: ATLAS COPCO AIRPOWER, NAAMLOZE VENNOOTSCHAP, Wilrijk (BE)

(21) Appl. No.: 18/559,739

(22) PCT Filed: May 24, 2022
(86) PCT No.: PCT/EP2022/064048

§ 371 Date: Nov. 8, 2023

(30) Foreign Application Priority Data
Jun. 2, 2021 (BE) BE2021/5441

(51) Int. Cl. B01D 53/04; B01D 53/26

(52) U.S. Cl. CPC B01D 53/0423; B01D 53/261; B01D 2257/80

(57) ABSTRACT

A device for purifying gas, the device including a vessel having an inlet for gas to be purified and an outlet for purified gas. In the vessel two or more blocks of a purifying agent are arranged which are stacked on top of each other to form a stack, in which a seal is arranged between the stacked blocks, in which the blocks are being held together by: an element extending through the blocks; and/or an enclosure made of a non-elastic or flexible material which is arranged around the stack of blocks; and/or the fact that the seals are glued to the blocks.

The present invention concerns a device for purifying gas.

More specifically, the invention concerns a device for purifying gas comprising a vessel having an inlet for gas to be purified and an outlet for purified gas.

The term “purifying gas” here means that the gas is purified from another gas, a liquid or another substance that is removed from the gas to be purified.

A purifying agent is placed in the vessel.

This purifying agent can take various forms, for example granules or for example a structured material in the form of one or more blocks. These are typically stacked on top of each other.

The purifying agent may, for example, be a drying agent, also called a desiccant, wherein the gas to be purified is dried, whereby water vapor will be separated from the gas by the desiccant. This happens, for example, classically in compressed gas from a compressor, wherein the compressed gas must be free of moisture before it is conveyed to the users.

Classically, the blocks of purifying agent or desiccant have a shape complementary to the shape of the vessel in which they are stacked.

The blocks have cavities, channels and the like through which the gas to be purified can flow.

In WO2017/035607 such blocks, when stacked, are anchored on top of each other using seals arranged around the blocks at the location where two blocks are stacked on top of each other, the seal having an inwardly projecting lip extending between the blocks.

The seal will anchor two successive blocks together, wherein the protruding lip keeps the blocks spaced apart from each other.

Since the geometry and location of the aforementioned cavities, channels and the like of the different blocks is different, it is necessary to keep the blocks spaced apart from each other such that one block cannot close the channels of the other block.

A heat shrink tubing is placed around the blocks, which is applied all around the circumferential wall of the stack of blocks, to ensure that the blocks remain stacked on top of each other.

As a result, one module or a so-called “cartridge” is formed which can be easily placed in the vessel and which will greatly simplify assembly and maintenance.

The present invention aims to provide an alternative to the aforementioned method of stacking and fixing the blocks of purifying agent.

The present invention has as an object a device for purifying gas, wherein the device substantially comprises a vessel having an inlet for gas to be purified and an outlet for purified gas, wherein the vessel contains two or more blocks of a purifying agent which are stacked on top of one another to form a stack, characterized in that a seal is arranged between the stacked blocks, the blocks being held together by:
an element extending through the blocks; and/or
an enclosure made of a non-elastic or flexible material which is arranged around the stack of blocks; and/or
the fact that the seals are glued to the blocks.

The three options mentioned above offer an alternative to the known solution consisting of a heat shrink tubing and seals.

An advantage is that the drawbacks associated with the use of a heat shrink tubing, such as for instance, the poor connection of the shrink tubing after mounting, are avoided.

Yet another advantage is that the aforementioned options allow to integrate other functionalities into the stack of blocks, or “cartridge”.

The aforementioned three options can be performed in different ways, as will be explained later.

Therefore, a preferred feature of the invention concerns the fact that the stack of blocks is provided at its ends with an inlet element and an outlet element, wherein one or more of the following components are provided in the inlet element:
inlet filter;
air distributor;
seal;
one or more flaps or valves;
silencer;
spring;
spacer;
water separator;
   and wherein one or more of the following components are provided in the outlet element:
exhaust filter;
air distributor;
seal;
one or more valves or valves;
silencer;
spring;
spacer.

Due to this far-reaching integration of different functions and components in the stack of blocks, the assembly of the device and in particular of the vessel will become much simpler.

Maintenance and possible repairs will also be done much smoother and more efficient.

In a preferred embodiment, the aforementioned seal extends over the circumferential edges of the blocks stacked on top of each other, the seal being constructed of a cylinder jacket which is arranged over the circumferential edges of the blocks and consists of two V-shaped positioned lips attached to the inside of the cylinder jacket and facing inwards, extending between the blocks, wherein the free edges of the cylinder shell are unfolded away from the blocks.

An advantage is that the free unfolded edges will be able to make contact with the inner walls of the vessel or with the inner walls of the enclosure, which will provide a seal to prevent leakage.

The V-shaped lips ensure that the blocks are maintained at a mutual distance.

In order to better demonstrate the features of the invention, some preferred embodiments of a device for purifying gas according to the invention are described below, by way of example without any limiting character, with reference to the accompanying drawings, in which:

FIG. 1 schematically represents a gas purification device according to the invention;

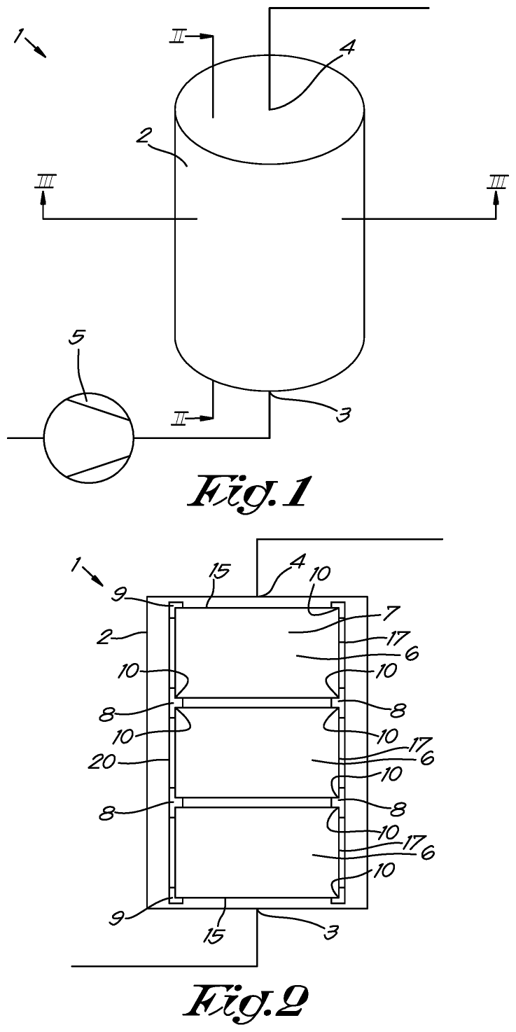

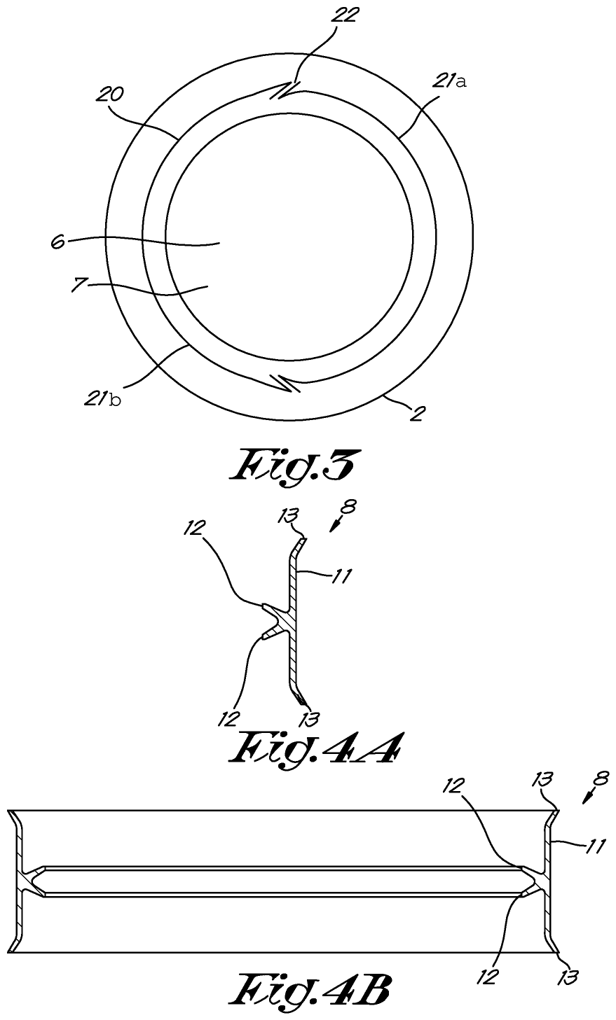

FIG. 2 represents a cross-section of the vessel of FIG. 1 along the line II-II in FIG. 1;

FIG. 3 represents a cross-section of the vessel of FIG. 1 along the line III-III in FIG. 1;

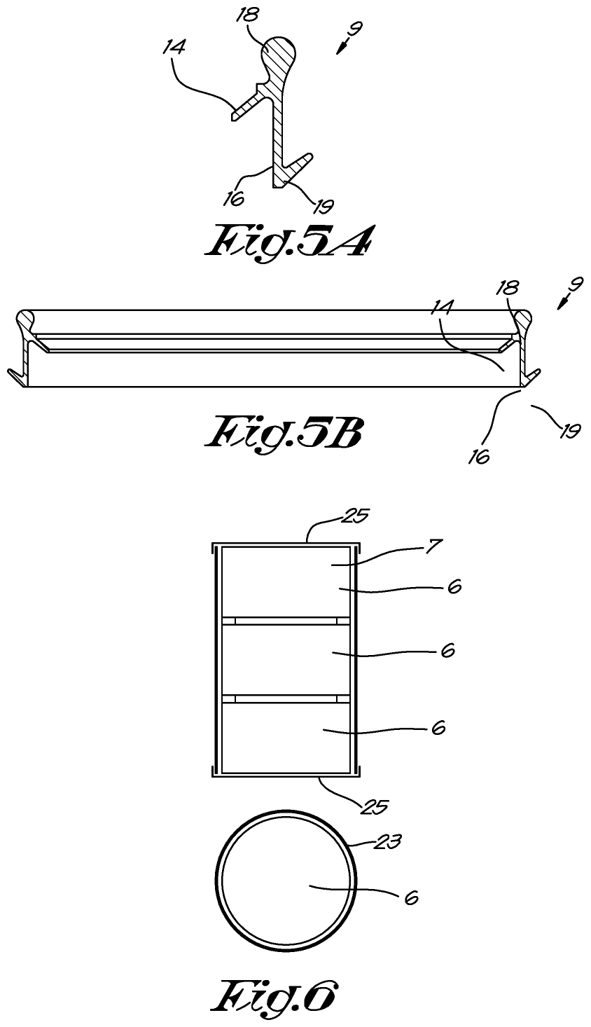

FIG. 4 shows a detail view of a seal of FIG. 2;

FIG. 5 shows a detail view of an end seal of FIG. 2;

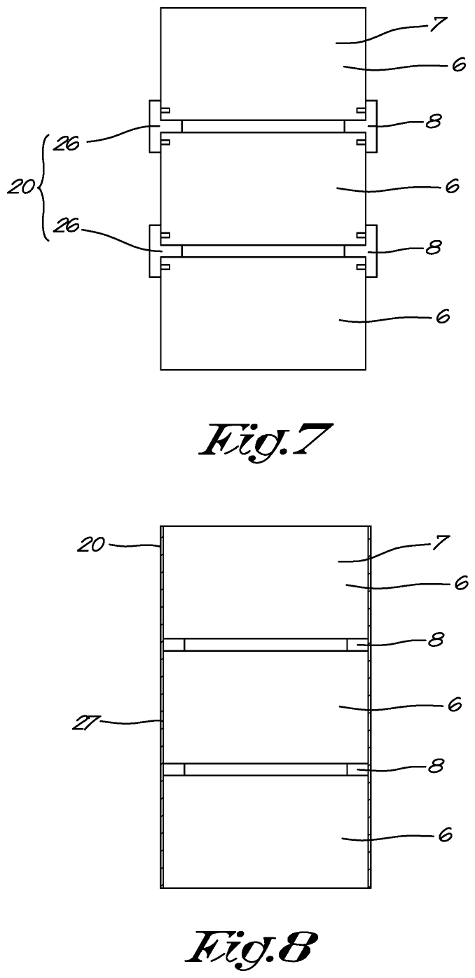

FIGS. 6 to 13 show variants of the stack of blocks of FIG. 2.

FIG. 1 schematically shows a device 1 according to the invention for purifying gas, comprising a vessel 2 with an inlet 3 for gas to be purified and an outlet 4 for purified gas.

In this case, the vessel 2 is cylindrical, but this is of course not necessary for the invention. The vessel may also be beam-shaped, for example, and have a square cross-section.

It is also possible for the device 1 to be provided with several vessels 2 in order to increase the capacity or, if the purifying agent is regenerable, to allow the vessels 2 alternately to be purified and regenerated.

In the example shown, the device 1 is more specifically a dryer for drying compressed gas, i.e. for removing moisture from the compressed gas to be purified, the gas originating from a compressor 5, but the invention is not limited thereto.

It will be clear that the device 1 can also be used to purify a gas that is contaminated with another gas by separating the contaminating gas from it.

Indeed, by “purifying gas” is here very generally meant that the gas is purified from another gas, a liquid or another substance that is extracted from the gas to be purified.

As can be seen in the cross-section in FIG. 2, a number of blocks 6 of a purifying agent is arranged in the vessel 2.

In this case, the purifying agent is a drying agent, also known as a desiccant.

The blocks 6 have a cylindrical shape, complementary to the shape of the vessel 2, as can be seen in FIGS. 2 and 3.

In this case, there are three such blocks 6, but there can be less or more than three as well.

The blocks 6 are stacked on top of each other to form a stack 7.

According to the invention, a seal 8 is arranged between the blocks 6 stacked on top of each other.

In other words, a seal 8 is arranged between each two blocks 6 stacked on top of each other.

A so-called end seal 9 is also arranged on both outermost blocks 6 of the stack 7.

In FIGS. 4 and 5, an example of the seal 8 and the end seal 9 is shown.

The aforementioned seal 8 as shown in FIG. 4 extends over the circumferential edges 10 of the stacked blocks 6.

The seal 8 is made up of a cylinder jacket 11 which is arranged over the circumferential edges 10 of the blocks 6 and consists of two V-shaped positioned lips 12 attached to the inside of the cylinder jacket 11 and facing inwards, extending between the blocks 6.

These lips 12 will ensure that the blocks 6 do not touch each other. It is important to ensure that the channels, openings and the like in the blocks 6 are not closed off because the blocks 6 make contact with each other.

In addition, the free edges 13 of the cylinder jacket 11 are folded open away from the blocks 6 and V-shaped lips 12, i.e. outwardly.

The end seal 9, which is provided on the outermost blocks 6 of the stack 7 of blocks 6 at their free circumferential edge 10, is designed as a V-shaped seal which is slid over the respective circumferential edge 10, all this in such a way that a first leg 14 of the end seal 9 presses against the axial top surface 15 of the outermost block 6, while the second leg 16 of the end seal 9 presses against the radial outer wall 17 of the block 6.

The end seal 9 is provided with a protrusion 18 where the two legs 14, 16 are connected to each other. In this case, this protrusion 18 is lobe-shaped.

Analogously to the aforementioned seal 8, the free end 19 of the second leg 16 is folded open away from the block 6.

According to the invention, the blocks 6 are held together.

By “held together” is meant here that they form one whole and can therefore be manipulated as a whole.

In the example of FIG. 2 and FIG. 3, this is done by an enclosure 20 made of a non-elastic or flexible material which is arranged around the stack 7 of blocks 6.

In this case, the enclosure 20 comprises two portions 21a, 21b which can be fastened to each other around the blocks 6.

The enclosure 20 may be made of metal or plastic, or the enclosure 20 may comprise a lattice or mesh material.

The portions 21a, 21b are attached to each other by means of a click system 22, as shown schematically in FIG. 3.

Of course, it is possible that there are more than two portions 21a, 21b or that the enclosure 20 consists of one piece that can be placed around the blocks 6 with only one click system 22.

Instead of a click system 22, it is also possible to use bolts or screws or other fastening means to fix the portions 21a, 21b together.

The aforementioned unfolded edges 13, 19 of the seals 8 and the end seal 9 will contact the enclosure 20.

This will provide a seal for the gas such that it cannot escape and is forced to flow through the entire stack 7.

The operation of the device 1 is very simple and as follows.

The air compressed by the compressor 5 will enter the vessel 2 via the inlet 3 of the device 1, where it will flow through the stack of blocks.

The blocks 6 of desiccant will extract the moisture present from the compressed gas.

The seals 8 and end seals 9 will prevent gas from escaping and reaching the outlet 4 without flowing completely through the stack 7 of blocks 6.

When the gas has flowed through the stack 7 of blocks 6, the moisture will have been removed from it and the now dried gas can leave the vessel 2 and the device 1 via the outlet 4.

The example shown in FIGS. 1 to 5 is only one possibility to keep the blocks 6 together.

FIGS. 6a and 6b show a variant according to FIG. 2, wherein, in this case, the enclosure 20 comprises a tube 23, duct or pipe which is arranged around the blocks 6.

The blocks 6 can be mounted herein loosely or with the aid of glue or sealing paste on the circumference of the enclosure 20.

An end cap 25 or cover is provided at both open ends 24 of the tube 23, duct or pipe.

These end caps 25 are made of a gas-permeable material.

In FIG. 7 the enclosure 20 is built up from different parts 26, each part 26 comprising a clamping system which can click into two successive blocks 6.

As shown in FIG. 7, each part 26 is a ring arranged around the blocks 6.

For example, the clamping system may comprise pins which penetrate into the blocks 6.

Alternatively, the clamping system can also comprise a rib-shaped bulge which fits into a groove provided for this purpose in the blocks.

The number of parts 26 is equal to the number of blocks 6, less one.

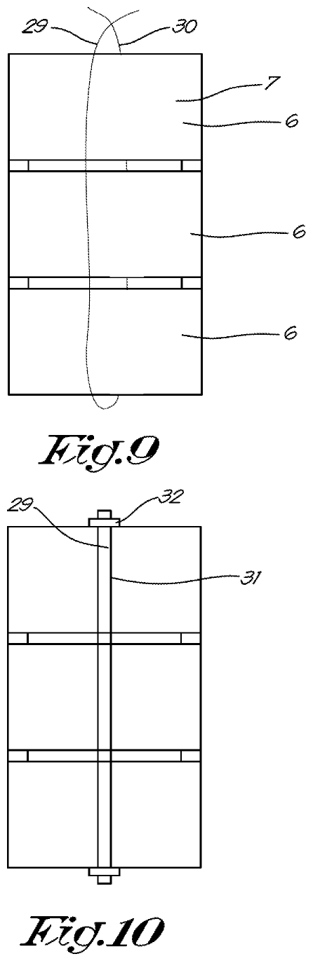

FIG. 8 shows a variant in which the enclosure 20 concerns a coating 27 which has been applied around the blocks 6.

Herein, the coating 27 is such that a strong enclosure 20 is obtained.

A possible coating 27 is, for example, a PU coating. However, any other coating with comparable resistance to pressure, vibration and shock than a PU coating and/or with comparable tensile bonding and sealing properties than a PU coating is suitable.

FIGS. 9, 10 and 11 show variants in which the blocks are held together by an element 29 extending through the blocks 6.

In FIG. 9, this element 29 is a wire 30 which is arranged through the blocks 6.

In particular, the two ends of the wire 30 are arranged through the stack 7 of blocks 6 and the ends are subsequently knotted.

In FIGS. 10 and 11, on the other hand, the element 29 is a rod 31.

In FIG. 10, the rod 31, arranged through the blocks 6, is provided at both ends with a nut 32 or the like for clamping the blocks 6 between these two nuts 32.

In FIG. 11 the rod 31 is provided at one end, in this case the lower end, with a stop 33 or abutment for the blocks, which stop 33 or abutment is gas permeable.

Also, in this case, the other end of the rod 31 is provided with a nut 32 or the like.

As can be seen in FIG. 11, a spring element 34 is arranged between the nut 32 and a block 6.

The spring element 34 will provide a tension or pressure on the blocks 6 such that they are pressed against each other and cannot move due to air speed or other influences.

The spring element 34 will also allow the blocks 6 to expand as a result of adsorption of moisture.

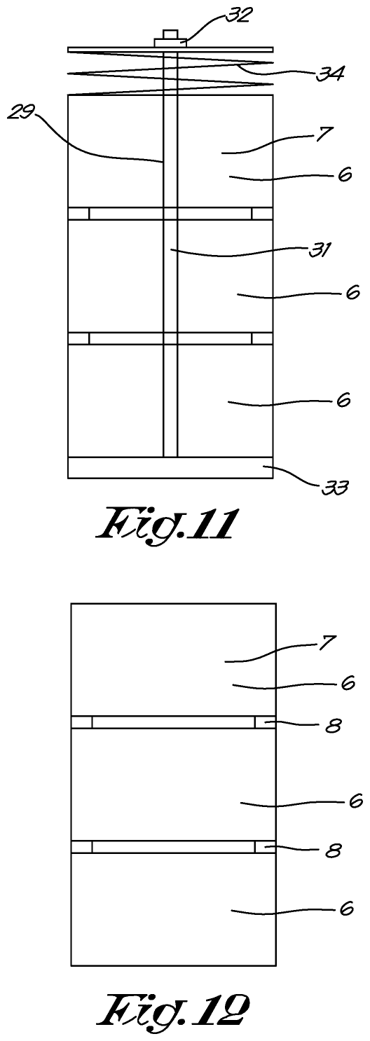

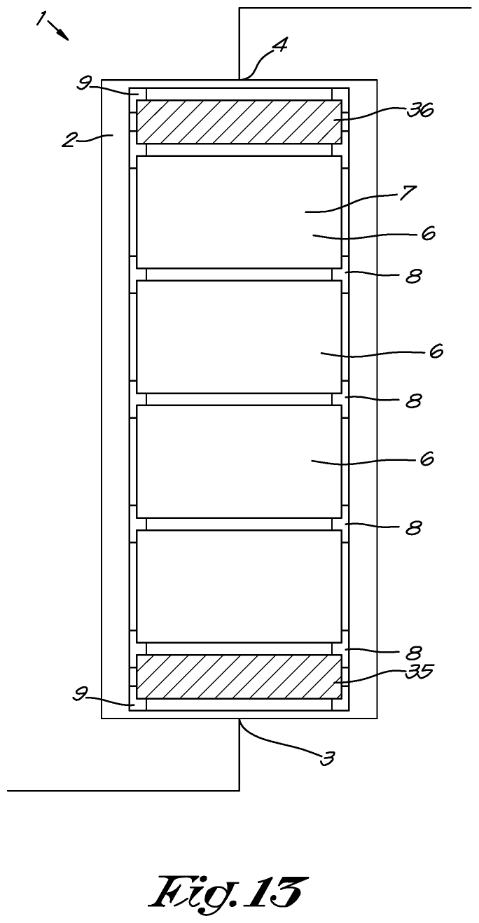

FIG. 12 finally shows the variant in which the seals 8 are glued to the blocks 6 in order to keep the blocks 6 together.

In other words, no enclosure 20 is arranged around the stack 7 of blocks 6, no element 29 is arranged through the stack 7 of blocks 6, or no heat shrink tubing is arranged around the stack 7 of blocks 6.

Another alternative embodiment concerns the connection of the blocks 6 to each other with the aid of an adhesive and strong tape instead of with an adhesive, such as for instance duct tape, which is glued over the perimeter of the blocks 6 between two successive blocks and optionally over the full perimeter of the blocks 6 is applied as protection.

In FIG. 13, a final alternative of FIG. 2 is presented.

The stack 7 of blocks 6 is provided at its ends with an inlet element 35 near the inlet 3 of the vessel 2 and an outlet element 36 near the outlet 4 of the vessel 2.

One or more of the following components is provided in the inlet element 35:
inlet filter;
air distributor;
seal;
one or more flaps or valves;
silencer;
spring;
spacer;
water separator.

By grouping all these components in the inlet element 35 and subsequently integrating them into the stack 7 of blocks 6, the assembly, installation, maintenance and repair of the device 1 is greatly simplified.

Analogously, one or more of the following components are provided in the outlet element 36:
exhaust filter;
air distributor;
seal;
one or more flaps or valves;
silencer;
spring;
spacer.

For example, the aforementioned spring element 34 could also be integrated in the inlet element 35 or in the outlet element 36.

It will be clear that the inlet element 34 and outlet element 35 can also be used in the embodiments of FIGS. 6 to 12.

The present invention is by no means limited to the embodiments described by way of example and shown in the figures, but a gas purification device according to the invention can be realized in all kinds of shapes and sizes without departing from the scope of the invention.

1-17. (canceled)

18. A device for purifying gas, wherein the device substantially comprises a vessel having an inlet for gas to be purified and an outlet for purified gas,
wherein in the vessel two or more blocks of a purifying agent are arranged which are stacked on top of each other to form a stack,
wherein a seal is arranged between the stacked blocks, wherein the blocks are being held together by:
an element extending through the blocks; and/or
an enclosure made of a non-elastic or flexible material which is arranged around the stack of blocks; and/or
the fact that the seals are glued to the blocks,
wherein the enclosure comprises one or more portions which can be fastened together around the blocks, said portions can be fastened to each other by means of a click system or bolts.

19. The device according to claim 18, wherein the element is a wire arranged through the blocks.

20. The device according to claim 18, wherein the element is a rod.

21. The device according to claim 20, wherein the rod is provided at both ends with a nut or the like for clamping the blocks between the two nuts.

22. The device according to claim 20, wherein the rod is provided at one end with a stop or abutment for the blocks, which stop or abutment is gas-permeable.

23. The device according to claim 22, wherein the other end of the rod is provided with a nut or the like.

24. The device according to claim 23, wherein a spring element is arranged between the nut and a block.

25. The device according to claim 18, wherein the enclosure comprises a hose or tube arranged around the blocks, wherein at both ends of the hose or tube an end cap or cover is fitted.

26. The device according to claim 18, wherein the enclosure is made of metal or plastic, or that the enclosure comprises a lattice-shaped or mesh-shaped material.

27. The device according to claim 18, wherein the enclosure is made up of several portions, each component comprising a clamping system that can snap into two successive blocks.

28. The device according to claim 18, wherein the enclosure is a coating which is applied around the blocks.

29. The device according to claim 18, wherein said seal extends over the circumferential edges of the blocks stacked on top of each another, the seal being constructed of a cylinder jacket which is arranged over the circumferential edges of the blocks and consists of two V-shaped positioned lips attached to the inside of the cylinder jacket and facing inwards, extending between the blocks, wherein the free edges of the cylinder shell are unfolded away from the blocks.

30. The device according to claim 18, wherein the outermost blocks of the stack of blocks are provided on their free circumferential edge with an end seal which is designed as a V-shaped seal, which is slid over the respective circumferential edge, such that a first leg of the end seal presses against the axial top surface of the outermost block, while the second leg of the end seal presses against the radial outer wall of the block, the end seal being provided with a protrusion where the two legs are connected to each other,
wherein the free end of the second leg is unfolded away from the block.

31. The device according to claim 18, wherein the stack of blocks is provided at its ends with an inlet element and an outlet element, wherein one or more of the following components are provided in the inlet element:
inlet filter;
air distributor;
seal;
one or more flaps or valves;
silencer;
spring;
spacer;
water separator;
and wherein one or more of the following are provided in the outlet element:
exhaust filter;
air distributor;
seal;
one or more flaps or valves;
silencer;
spring;
spacer.

32. The device according to claim 24, wherein said seal extends over the circumferential edges of the blocks stacked on top of each another, the seal being constructed of a cylinder jacket which is arranged over the circumferential edges of the blocks and consists of two V-shaped positioned lips attached to the inside of the cylinder jacket and facing inwards, extending between the blocks, wherein the free edges of the cylinder shell are unfolded away from the blocks, and
wherein the spring element is integrated in the inlet element or in the outlet element.
